(19) United States
(12) Patent Application Publication
(10) Pub. No.: US 2006/0123679 A1
(43) Pub. Date: Jun. 15, 2006

(54) Battery powered, solar recharged, self contained, universal reflective character display unit

(75) Inventor: Debra Scruggs, Madison, AL (US)

Correspondence Address: DEBRA M. SCRUGGS, 117 ROYAL DRIVE, APT. 3502, MADISON, AL, 35758, US

(73) Assignee: Debra Scruggs, Madison, AL (US)

(21) Appl. No.: 10/905,034

(22) Filed: Dec. 11, 2004

(51) Int. Cl. G09F 13/02

(52) U.S. Cl. 40/559

(57) ABSTRACT

My invention creates a method of utilizing battery powered, solar rechargeable, universal self-contained character display units useful for creating attention-getting messages, location identifiers such as maps, and address identification display modules. A typical embodiment consists of a container unit comprising an elevation and rotationally adjustable solar panel, an extended power life rechargeable battery, a night/day sensor/switch, an appropriate number of ultra bright, long life LED light sources. In nighttime or low light conditions, the LED(s) illuminate a passively reflective character imprinted on an interchangeable character board.

My invention is a battery powered, solar recharged, self contained, character display unit suitable for indicating addresses, for displaying messages, and for providing useful information in a visual manner. The technology I use for my invention is scalable and adaptable to a variety of display embodiments. To demonstrate my invention's capabilities and to fulfill the requirement that someone reasonably skilled in the art could reproduce my invention, I describe a small, rectangular unit as a typical embodiment. Many other display shapes and sizes are feasible as long as the relationships among the technology components are adhered to. My demonstration embodiment is approximately 4.25 inches wide×6.75 inches high×2.5 inches deep, totally enclosed, watertight, battery powered, and solar rechargeable. Each unit displays a slightly raised, reflective white on low gloss black character board approximately 5.5 inches high by 2.75 inches wide. Each character unit has its own externally attached solar array assembly to recharge its own independent battery power supply that powers its illuminating LED. The exterior container of the character unit may be made of wood, plastic, or composite materials.

The container consists of three areas; two separated internal areas and an outside area. The first area, a rear internal compartment, contains the batteries (3 each AA in this demonstration embodiment), the night/day switch, the power control board, and associated wiring and mounting hardware. The second area, a front internal compartment, contains the character board (the board is removable and is the separator between the two areas) with its painted, raised, white reflective number or letter, the painted low gloss black background, and the LED light sources which are high intensity units, focused on to the face of the character board. This compartment is completed with a full front cover of very clear, very tough form fitted sheet of Lexan (or equivalent transparent plastic material). The third area, outside, above, and attached to the rear area, is the night/day sensor and solar cell array which has approximately 180 degrees rotational and approximately 75 degrees upward tilt from the horizontal level. This solar module is approximately 4.0 inches×8.0 inches×1.0 inch and is sized to give unobstructed assembly of the units into a module, while sustaining adequate unit power.

Each character unit is a totally independently functioning system having its own solar panel, battery power system, character board, and protective cover. The make-up of an address identification, message, or information module consists of one or many independent units as desired for display. For example, to display the address “123A”, a single medium sized unit could be employed or 4 small independent units aligned and mounted in close proximity could be used. To display a layout map of a local shopping center, a single, large unit could be used or a combination of smaller units showing various sections of the location might be utilized.

Because of its flexible design and modular components, units can have one or more of the following methods of display as desired:

(1) Stake mount

(2) Post mount

(3) Sign mount

(4) Wall mount

Other mounting methods may be included on an as requested basis.

### SPECIFICATIONS

The below listed component specifications of the demonstration embodiment are provided so someone reasonably skilled in the art can duplicate my invention. As the unit sizes increase or decrease to accommodate other embodiments, the particular values of a component might change.

Solar Array
(5) Basic specification principle: Sufficient surface area to keep the batteries charged, able to rotate and tilt to align with local solar patterns for maximum efficiency. In the demonstration embodiment, the values are:
(6) +4.5 volt, 200 milliamp or similar
(7) open circuit voltage (full sun)—+5.2 volts
(8) shorted current—220 milliamps
(9) Max load current—70 milliamps
(10) Average load current—30 milliamps
(11) Size—approximately 4 inches×8 inches×1 inch

Batteries
(12) Basic sizing principle: Sufficient voltage characteristics and duration to keep the LED light sources illuminated. In the demonstration embodiment, the values are:
(13) 3 each size AA
(14) Nickel Metal Hydride or Lithium
(15) Rechargeable 1.2 volt, 1800 milliamp minimum per battery
(16) Environmentally friendly

Light Emitting Diode (LED)
(17) Basic sizing principle: Sufficient brightness intensity to illuminate the information being displayed and appropriate voltage characteristics to match the battery power solar recharge system. In the demonstration embodiment, the values are
(18) bright white, round, 5 mm, T1¾
(19) 3.6 volt
(20) 30 milliamp
(21) 2000 millicandela (mcd) minimum, 2500-3000 mcd preferred for maximum illumination

Dusk to Dawn Sensor/Switch
(22) Off the shelf photodiode, sufficient for the embodiment
(23) Power Control Board with mounts
(24) Off the shelf unit sufficient to control the on and off operation of the power source. In the demonstration embodiment, the power control board is a 2 inches by 1¾ inches circuit board with mounts

Battery Holder
(25) Off-the-shelf, sufficient to hold the number of batteries required by the embodiment. The demonstration embodiment holds 3 AA nickel metal hydride batteries (NiMH) in series, with power output leads

Dusk to Dawn Sensor

(26) Sensor located within solar array assembly

Dusk to Dawn Switch

(27) Off the shelf photo-diode, located on power control board

Character Board
(28) Sufficient size and visual contrast characteristics to convey the desired information. The demonstration embodiment uses an off the shelf reflective white painted-on character with black background

### PRIOR ART

The field of endeavor of this invention deals with advancing the art of displaying visual information such as address identification, messages, or location maps by increasing the chances the information will be noticed in both daytime and nighttime conditions, by increasing the brilliance of the illumination system in nighttime or low light conditions, by freeing the address display from cumbersome ties to failure-prone AC electrical circuits, by enhancing the emergency response usefulness in the case of public power failure, by clearly locating addresses or location information or displaying critical information in nighttime conditions in unlit rural areas and other hard to see locations, and by adding flexibility in the selection and change of specific visual information characters such as address identifiers, messages, and location indicators.

In my preparation of this patent application I found that many techniques and devices for harnessing solar energy for heat or production of electrical energy, including the use of solar panels to recharge batteries, are in general public use and are documented in US patent office class 126 (solar collector systems). As I researched other US patent classes, especially class 40 (includes sign exhibiting), and class 362 (includes illumination), I observed a number of patents that in some degree are relevant to this invention in structural and functional characteristics but which also illustrate some characteristics of the prior art that can be improved by my invention.

(29) U.S. Pat. No. 5,007,190, April 1991, Shyu

(30) U.S. Pat. No. 5,522,540, June 1996, Surman

(31) U.S. Pat. No. 5,573,328, November 1996, Hwang

(32) U.S. Pat. No. 5,819,455, October 1998, Tsuda

(33) U.S. Pat. No. 6,131,321, October 2000, Daigle

(34) U.S. Pat. No. 4,993,058, February 1991, McMinn, Lloyd, Middleton

(35) U.S. Pat. No. 4,931,780, June 1990, LaMont, LaMont, Donnell

(36) U.S. Pat. No. 4,611,265, June 1986, Davis

(37) U.S. Pat. No. 5,649,378, July 1997, Roesser, Martins

(38) U.S. Pat. No. 5,408,773, April 1995, Hwang

(39)

(40)

Inventor's Comments on the Prior Art (see paragraphs below).

U.S. Pat. No. 5,007,190, April 1991, Shyu. My invention uses a brighter LED illumination source to reflect upon a larger character area than the internally lit LED source used by this invention.

U.S. Pat. No. 5,522,540, June 1996, Surman. This invention uses a solar panel to charge batteries which power the illumination of reflective address numbers designed exclusively for mailbox installation. While the power system and reflective numerals used are similar to the design I use and indeed, similar with anyone's invention using solar power to recharge batteries to illuminate characters, my invention's design emphasizes single character modularity for maximum flexibility, the added clarity and brilliance of high intensity LED illumination, and the added ease of not being tied to a fixed mailbox location for location to the most advantageous visibility point.

U.S. Pat. No. 5,573,328, November 1996, Hwang. My invention uses a much simpler circuit for increased reliability, better illumination with bright white LEDs rather than fiber optic tubes, and easier to access container construction.

U.S. Pat. No. 5,819,455, October 1998, Tsuda. This invention uses a solar panel to recharge batteries that provide illumination of pre-set patterns. The use is described exclusively for traffic signs. My invention uses a much simpler design to illuminate a character and is intended for flexibility in displaying various types of visual information.

U.S. Pat. No. 6,131,321, October 2000, Daigle. My invention uses a much simpler circuit for increased reliability, better illumination with bright white LEDs lighting the characters from the front, and provides more flexibility in using individual characters rather than an unchangeable character block.

U.S. Pat. No. 4,993,058, February 1991, McMinn, Lloyd, Middleton. To more reliably provide address identification in the event of commercial utility and telephone failure, my invention uses self-contained solar recharged battery power, and requires no user intervention.

U.S. Pat. No. 4,931,780, June 1990, LaMont, LaMont, Donnell. As above with U.S. Pat. No. 4,993,058, my invention uses self-contained solar recharged battery power, and requires no user intervention to more reliably provide address identification in the event of both commercial utility and telephone failure

U.S. Pat. No. 4,611,265, June 1986, Davis. Unlike my invention's self contained battery power, brilliant front lit LED design, and flexible information display sizing area, this invention is dependent on commercial utility power for operation, has backlit shadowbox type illumination, and uses smaller, non-reflective characters on a single address board.

U.S. Pat. No. 5,649,378, July 1997, Roesser, Martins. My invention uses brilliant LED illumination, large reflective single characters, and a self-contained solar recharged battery power system rather than the public utility dependent AC power source and combined character string of this invention.

U.S. Pat. No. 5,408,773, April 1995, Hwang. Though a white character on black background is used here, my invention uses a simpler but brighter LED illumination rather than the optical fiber tubes used here. My use of a self-contained solar recharged battery power system also eliminates the dependence of commercial utility power. My modular character unit provides more flexibility in character arrangement.

In summary, my observation and review of these relevant patents disclose some substantial differences with this invention in structural and functional characteristics. A description of how my invention solves the observed drawbacks of the relevant patents is described below.

### BRIEF SUMMARY OF THE INVENTION

As described above, the prior art for displaying various types of visual information such as location maps, messages, and address identification was often tied to a single location such as a mailbox or address box attached to the side of a house, necessarily physically connected to commercial utility power further limiting its location, unable to function in the event of commercial utility failure, and often poorly illuminated in low light or nighttime conditions.

My invention is a battery powered, solar rechargeable, self-contained, universal reflective information display unit, utilizing the full functional potential of selected state of the art innovative, structural, mechanical, electrical and feature components, in obtaining the highest visual quality and extended functional reliability day and night (24 hours a day, 7 days a week) for any reflective characters, message, or information selected for display. This display is accomplished by installing a display unit (or units) of a size and shape appropriate for the information, a passive reflective character board containing a reflective character or characters which convey the message, location identification characters, or other visual information such as maps into its slide-in, slotted location. As a universal display unit, this passive character board is removable and interchangeable with any selected reflective character board at any time with no impact on the exceptional long-term reliable operational or functional qualities of the character display unit. Furthermore when this universal display unit is embodied into an address display, message, or location indicator module, whether single or multiple units, the passive character board is the only component change consideration required to display and or to make a change to the selected information. Therefore, the same high visual quality and long term reliability of the functional qualities of the unit remain totally intact throughout the various desirable embodiment configurations of this invention.

The performance of the selected embodiment of this invention will give continual high confidence in the display of any desired character or characters, message, or location identifier under a wide variety of visibility conditions. The unit will also have long term functional reliability, using matching highest quality state of the art solar cells, batteries, day/night switch, and LED illumination.

The solar unitized information display module consists of a passive alignment and retaining mount assembly, the characters, message, or location information to be illuminated (from one to as many as required), and a totally self-sustaining active display unit. The mount assembly will align and retain the active display unit(s) in any order desired in order to accommodate different address identification formats. The mount assembly also serves to attach the module to its mounting stake, post, sign, wall or any other display arrangement desired. With the solar panels on each unit having rotational and tilt adjustments, many locations can be considered for locating these functional and decorative address identification modules

### TYPICAL EMBODIMENT

Referring to FIG. 1, a single character display unit (31) is displaying its assigned character behind its protective Lexan plastic front (11) and surrounded with its strong, weather-tight and attractive structural containment body (31).

Referring to FIGS. 2, 3, 4, 5 and 6, the display unit has a removable top (13) which is easily removed by removing holding screw (15) from the accessible back (19) and pulling the top (13) straight up and away from the guide pins (14) mounted to the sides (20, 21) and back (19). The top (13) is re-installed by placing it directly over the guide pins (14) and pressing down until tight and then installing the holding screw (15). The removal of the top (13) allows complete and open access to the removable front (11), the removable character board (10) and the removable power board (9).

Referring to FIGS. 2, 3, 4, 5, 6, 8, 9, and 10, the unit can be seen to be a highly visual, highly reliable unit capable of 24 hours a day 7 days a week night and day operation. During daytime operation, the night/day sensor (30) signals the night/day switch (29), keeping open the power supply circuit (6) to the LED light source (8). There is thus no power load on the system so the solar panel (1), which is always connected to the batteries, will recharge the batteries as needed. As the daylight begins to fade into night, the night/day sensor (30) will signal the night/day switch (29) to close and thus turn on the LED light source (8), illuminating the character board character (27).

Referring again to FIGS. 2, 3, 8, and 9, the front Lexan panel (11), the character board (10), and the power board (9) are installed by inserting each into the assigned guide slots (22, 23, 24) in side panels (20, 21). The LED light source (8) is mounted in the cutout (25) at a 3-degree rearward angle, with this cutout (25) having a reflective surface material (26) giving maximum light coverage of the character board character (27). The electrical cabling (5) is routed through the drilled opening in the bottom (12) to the terminal board (7) where it is wired through the day/night switch (29) on to the connecting terminals of the cabling from the batteries (6). Also connected to these terminals is the electrical cabling going to the solar panel (1) via drilled opening (28) on the back panel and connectors (4), cabling (3), and mounting tube (2). The solar panel (1) has tilt and rotation capabilities on its mount and can be locked to most any desired position.

The electrical cabling (3) for the solar panel (1) is encapsulated in a weatherproof tubing and with connectors (4) can be manufactured to most any length, giving flexibility to the location for the solar panel (1) mounting. The normal mounting mode is for the solar panel to be attached to the character display unit (31) alignment and mounting assembly with mounting blocks. These mounting assembly blocks are not included as a specified component of this invention since they will vary with the exact location of the solar panel. Refer to FIG. 7 for an illustration of the preferred embodiment.

The character display units (31) are assembled and the selected character board (10) with its reflective character (27) is installed inside. The units (31) can be placed in an address identification sequence (see FIG. 7). In this embodiment, each module is mounted to a pipe alignment and mounting assembly (32) that has the hook-on mounting blocks for the display units making up the module. The individual solar panels (1) are mounted on a common frame and the individual electrical cabling (3) for each solar panel (1) is routed down through the pipe alignment and mounting assembly (32) and on to the corresponding unit (31). The common mounting frame for the solar panels (1) can be rotated and tilted for maximum solar energy capture and then locked into position.

Again, referring to FIG. 7, the embodiment of the character display units as an address identification module is but one way of using the various characters to communicate information or a message.

### BRIEF DESCRIPTION OF SEVERAL VIEWS OF THE DRAWINGS

FIG. 1 is a front elevation view of the character display unit with a single character board character displayed.

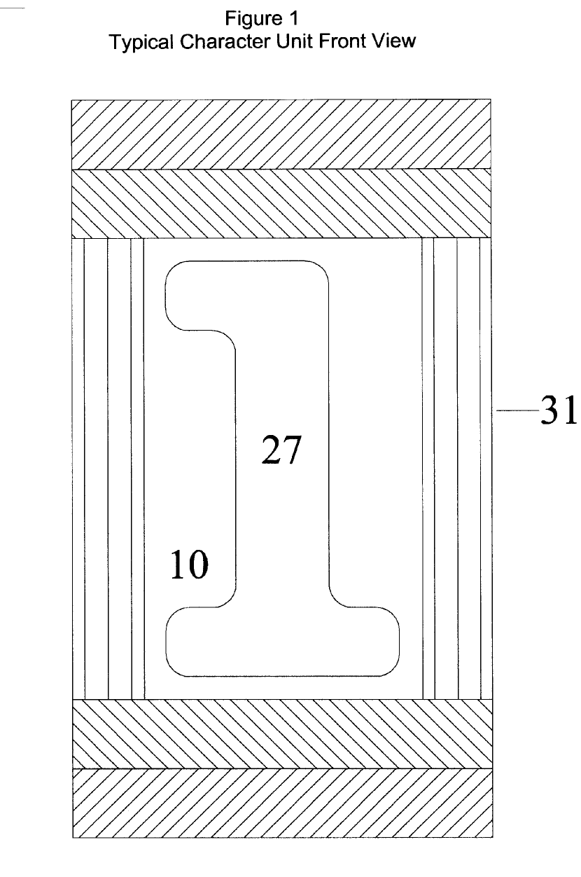

FIG. 2 is a right side elevation with the structural side panel removed for unit detail display.

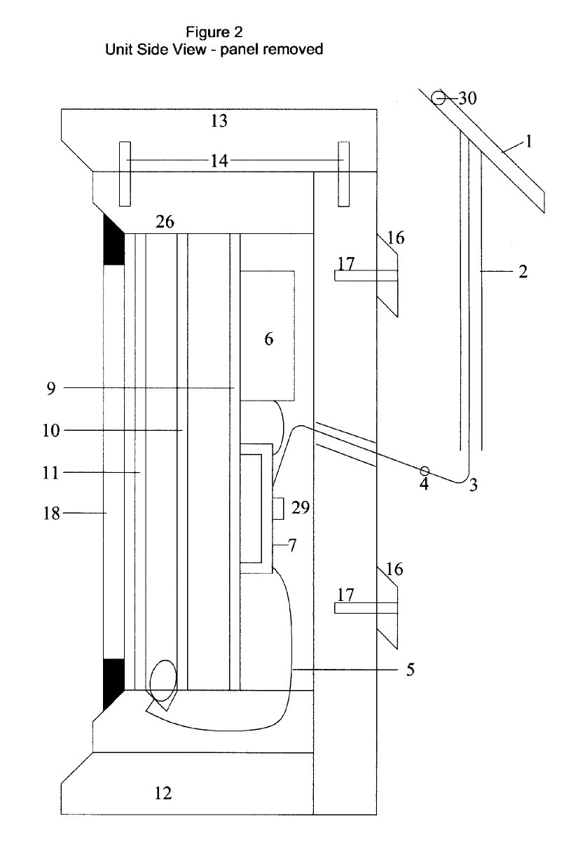

FIG. 3 is the right side panel depicting slide-in slots for the power board, character board and Lexan front. A left side panel mirror image is shown also.

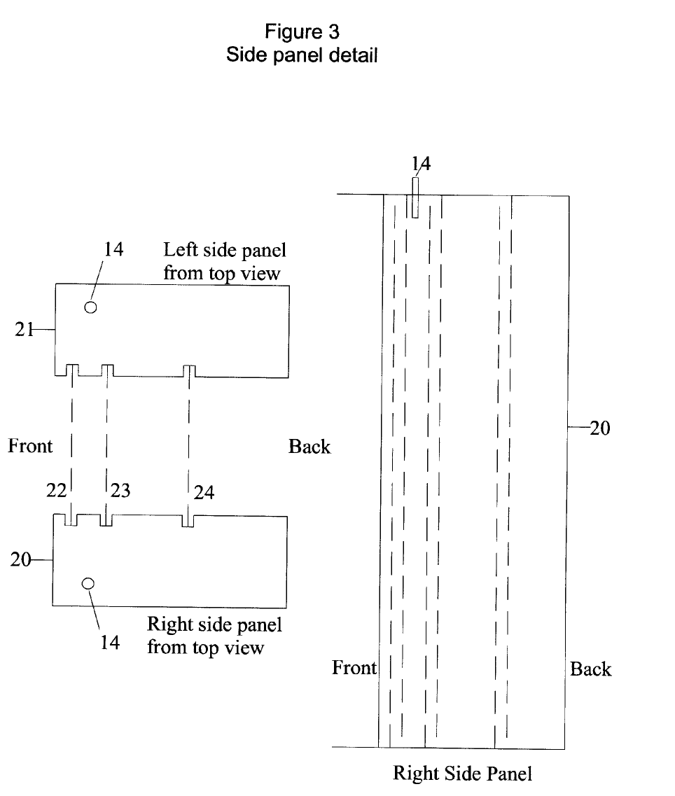

FIG. 4 is the layout of the power board with mounted components.

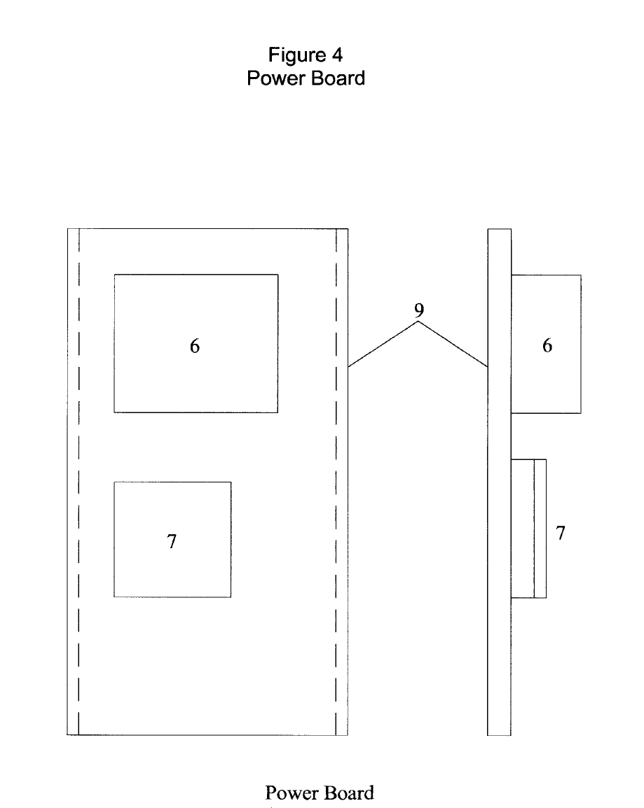

FIG. 5 is the character board with a single reflective character display.

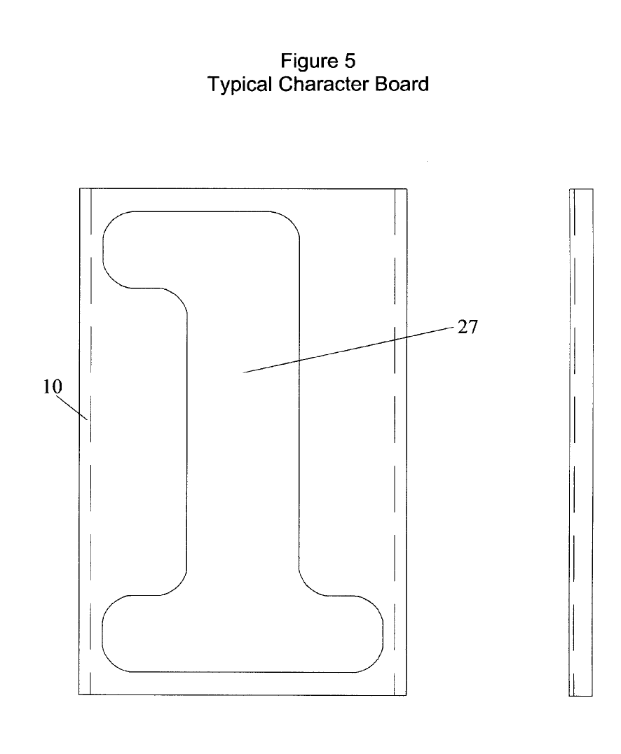

FIG. 6 is the back panel with alignment and mounting assembly attached.

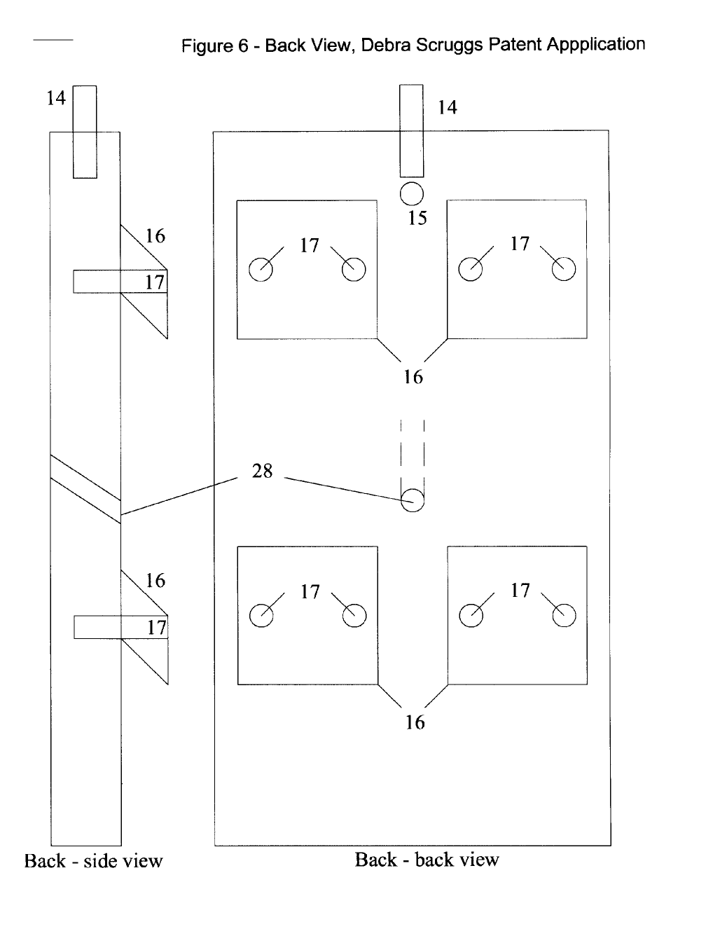

FIG. 7 is the preferred embodiment of the single character display unit.

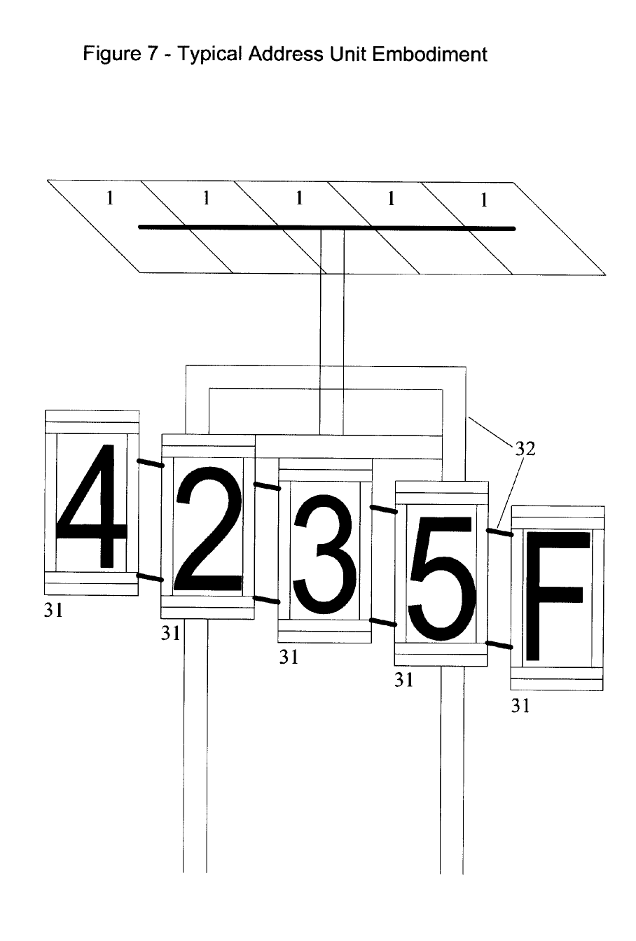

FIG. 8 is the character unit functional block diagram.

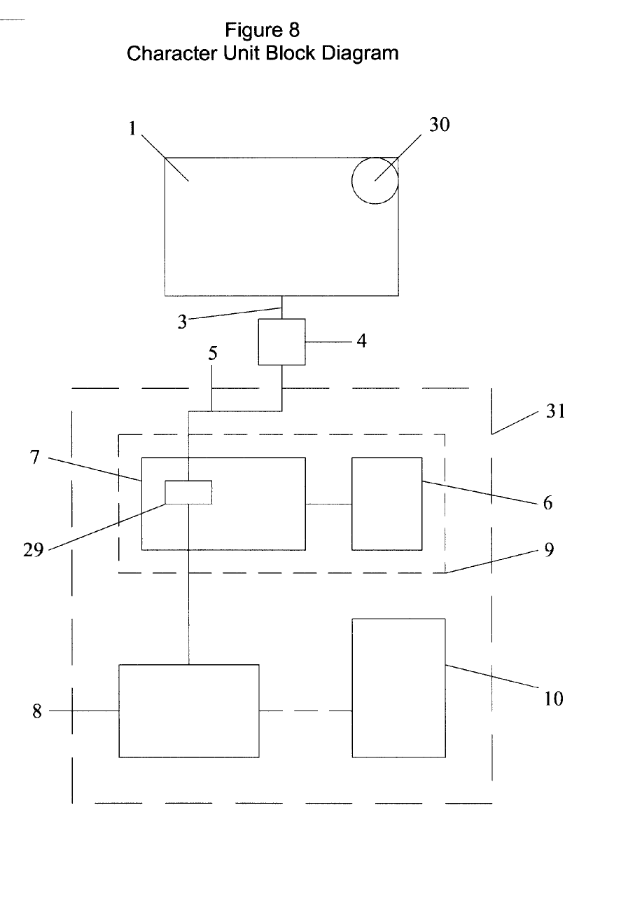

FIG. 9 is the character unit electrical schematic.

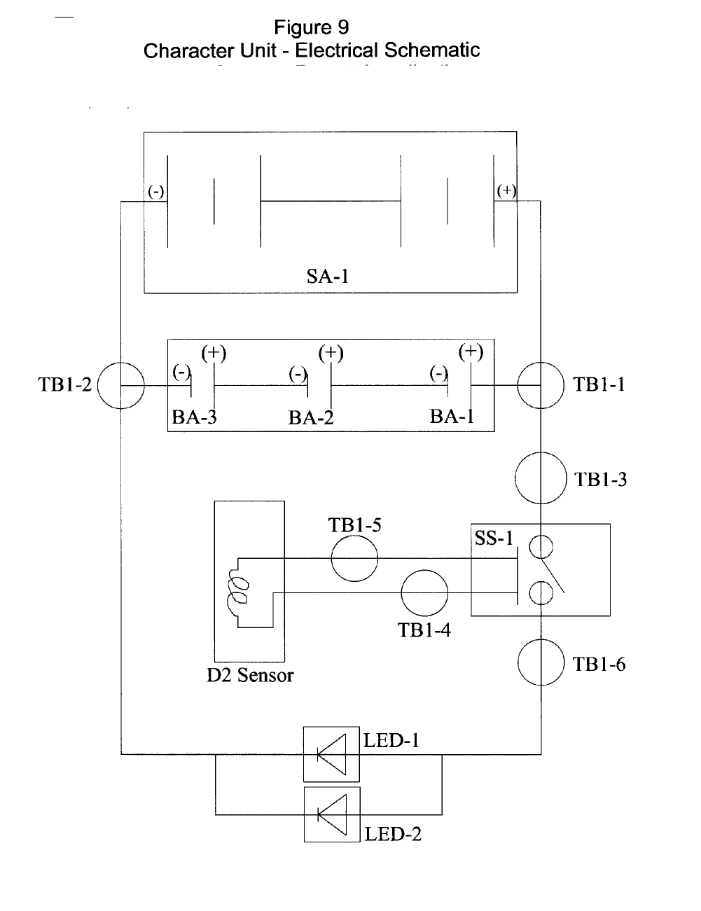

FIG. 10 is the side view of the removable top and the side view and front view of the bottom depicting the cut-out and LED location.

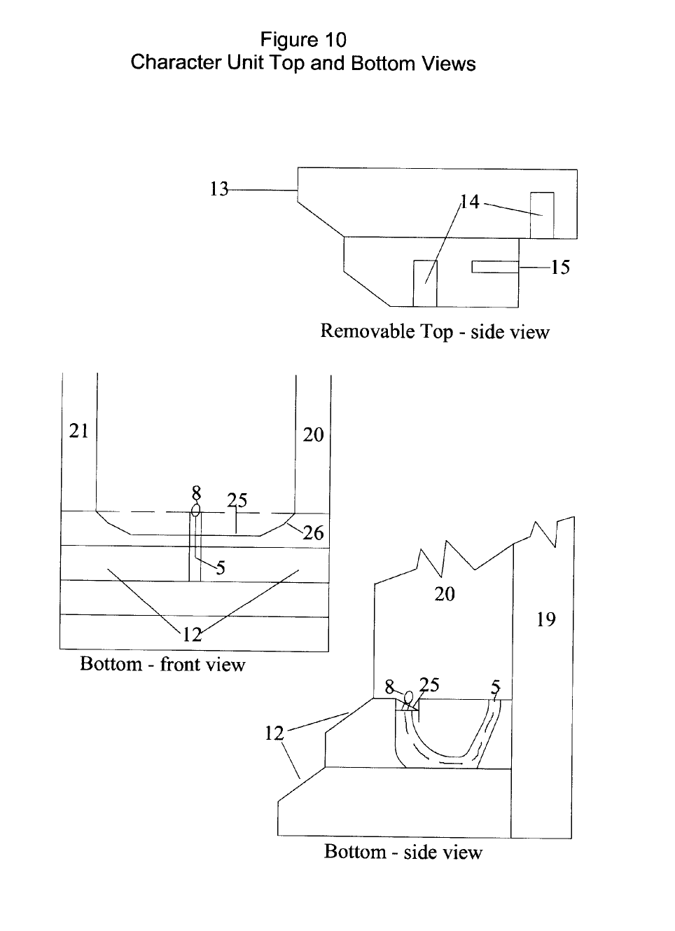

Key to component numbers used in all drawings.

Solar panel—1

Solar panel mount tubing—2

Outside electrical cabling—3

Electrical cabling connectors—4

Internal electrical cabling—5

Battery holder (3 batteries)—6

Terminal board with mounts—7

Light Emitting Diode (LED)—8

Power board (removable)—9

Character board (removable)—10

Front (Lexan plastic)—11

Bottom of unit—12

Top of unit (removable)—13

Top guide pins—14

Top attachment screw—15

Unit mounting attachment—16

Unit mounting attachment holding screw—17

Decorative panel—18

Unit back—19

Right side panel—20

Left side panel—21

Guide slots for Lexan front—22

Guide slots for character board—23

Guide slots for power board—24

Cutout for LED—25

Reflective material—26

Character board character—27

Electrical cabling access—28

Night/day switch—29

Night/day sensor—30

Character display unit—31

Alignment and mounting assembly—32

What is claimed is:

1. a self-contained, universal character and information display unit that improves the prior art by increasing the illumination of the information characters, eliminating the dependence on commercial utility power, and adds flexibility to the selection and arrangement of the separate characters into an information display unit.

2. said unit utilizes selected off the shelf and functionality matched components, minimum in quantity and maximum in specification qualities, state of the art active components—solar panel matched with battery, battery matched with LED light source, light source matched for illumination performance.

3. said solar panel being adjustable for rotation and elevation, being physically removable from the character alignment and mounting methods while staying electrically hard connected.

4. said batteries being solar rechargeable, deep cycle, long life, high capacity output, environmentally friendly.

5. said light source being ultra bright white LED(s) of exceptionally long life.

6. An off the shelf reliable night-day sensor-switch for 24/7 operation.

7. A passive removable universal interchangeable character board for presenting any desired character for display (address identification, message, location identifier such as a map).

8. Said character board can effectively utilize high contrast, reflective information boards such as the demonstration embodiment's high-gloss reflective white character painted on low gloss black background.

9. A container unit of various sizes and shapes for enclosure of said components and attaching mechanism for mounting unit and attachment of solar panel mounting to unit.
